(19) United States
(12) Patent Application Publication
(10) Pub. No.: US 2025/0228322 A1
(43) Pub. Date: Jul. 17, 2025

(54) HELMET

(71) Applicant: ABUS August Bremicker Söhne KG, Wetter-Volmarstein (DE)

(72) Inventors: Frank RIEDERER, Dortmund (DE); Marc VON DUNTEN, Essen (DE); Niklas BAUMEISTER, Wuppertal (DE)

(21) Appl. No.: 19/011,696

(22) Filed: Jan. 7, 2025

(30) Foreign Application Priority Data
Jan. 17, 2024 (DE) 102024101336.2

(51) Int. Cl. A42B 3/04; B29C 44/02; B29C 44/44; B29K 105/04; B29K 311/02; B29L 31/48

(52) U.S. Cl. CPC A42B 3/04; B29C 44/02; B29C 44/445; B29K 2105/048; B29K 2311/02; B29L 2031/4821

(57) ABSTRACT

A helmet, which can, for instance, be a sports helmet or a work safety helmet, comprises a helmet body composed of at least a first material and a second material different from the first material. In this respect, the helmet body comprises, on the one hand, a solid foam of expanded foam particles of the first material and, on the other hand, particles of the second material that have an adhesive connection, in particular are joined in a materially bonded manner, with at least some of the expanded foam particles of the first material.

### CROSS-REFERENCE TO RELATED APPLICATION

This application claims the benefit and priority of German Patent Application No. 102024101336.2 filed on Jan. 17, 2024. The entire disclosure of the above application is incorporated herein by reference.

### FIELD OF THE INVENTION

The invention relates to a helmet, in particular a sports helmet or a work safety helmet.

### BACKGROUND OF THE INVENTION

A helmet serves to protect the respective wearer of the helmet from head injuries in the case of a fall or of an impact of an object on the head of the wearer. Depending on the application, the protective helmet may serve and be configured as a sports helmet or a work safety helmet, for example as a bicycle helmet or a riding helmet. In particular when used as a bicycle helmet, the helmet may have one or more ventilation openings to support a passive cooling of the head of the wearer by environmental air or headwind.

The helmet typically comprises a helmet body that has an at least substantially (for example, only apart from said ventilation openings) concavely shaped inner side, which faces the head of the wearer of the helmet when the helmet is put on, and an at least substantially convexly shaped outer side opposite thereto. The helmet body is adapted in terms of shape, thickness and material to absorb the kinetic energy acting on the helmet during a shock (crash or impact) as much as possible through inelastic and/or elastic deformation. Such shock-absorbing properties may in particular result from the helmet body being made of solid foam.

It is common practice to configure the helmet body according to the so-called in-mold technique by back-injecting a previously separately manufactured outer helmet shell. In principle, however, the helmet body may also be manufactured independently of a helmet shell as a mold body made of solid foam. The solid foam is in this respect formed by expanding foam particles of a suitable material within a defined mold. The helmet body may generally be formed entirely by the solid foam. The helmet body then consists entirely of the material of the solid foam so that its properties substantially result from those of the foamed material. However, it may be desirable for the helmet body to have properties or fulfill functions that cannot be implemented with a single material.

Thus, it may, for instance, be expedient to form different regions of the helmet body from different materials. For example, the helmet body may comprise multiple layers that are differently compressible or shearable to absorb impact or shear forces of different types or magnitudes; or the helmet body may have padding sections at its inner side for a comfortable fit on the head of the wearer; for mechanical reinforcement, the helmet body may comprise a reinforcing structure at which the shock-absorbing solid foam is arranged, or other reinforcing elements that are embedded in the foam.

To combine the advantageous properties of different materials, the helmet body may be made from a plurality of separately manufactured parts of different materials that are fastened to one another after their manufacture. However, the manufacture of a plurality of separate parts from different materials that are joined with one another after their manufacture leads to a comparatively high effort when producing the helmet. Furthermore, the connections between the separately manufactured parts may possibly not be as stable as the respective parts themselves, which may impair the safety of the helmet.

### SUMMARY OF THE INVENTION

It is an object of the invention to provide a helmet of the aforementioned kind that may be easily manufactured and that may in this respect be particularly flexibly used with a high level of safety, in particular in that said helmet may combine a particularly large number of different advantageous properties and/or functions.

The object is satisfied by a helmet having the features of claim 1. Advantageous embodiments of the invention result from the dependent claims, from the present description, and from the Figures.

According to the invention, the helmet, which may in particular be a sports helmet or a work safety helmet, comprises a helmet body composed of at least a first material and a second material different from the first material. In this respect, the helmet body may have an at least substantially concavely shaped inner side, which faces the head of the wearer of the helmet when the helmet is put on, and an at least substantially convexly shaped outer side opposite thereto.

According to the invention, it is provided that the helmet body comprises a solid foam of expanded foam particles of the first material. The helmet body may thereby form the central shock-absorbing element of the helmet. The solid foam may generally be elastically deformable (to a certain extent). However, the solid foam is preferably a hard foam so that the solid foam is at least substantially only plastically deformable.

The foam is formed from expanded foam particles. These foam particles, which may at least substantially have a spherical shape, are small particles, in particular so-called foam beads or beads. The foam particles may, for example, have a maximum diameter in the order of millimeters (0.5 to 15 mm). The foam particles may be pre-foamed, i.e. may already be formed as foam, for example from a microgranulate or directly from the melt of a foamable material, in particular a polymer. In this respect, the foam particles initially have a comparatively dense structure (small cells) and may be caused to expand, in particular by supplying heat.

If a defined space of a certain shape is at least largely filled with such foam particles that are not yet (completely) expanded and the foam particles are then caused to expand, they expand into the remaining intermediate spaces, in particular such that they ultimately occupy the entire space. Typically, the expanding foam particles are in this respect pressed against one another so that they adhere to one another, stick together or even fuse. This is also due to the fact that they temporarily lose their solid form during the expansion and become soft. In this respect, the foam particles may also melt at least partly, in particular if heat is supplied to them for the expansion. The foam particles are preferably joined with one another in a materially bonded manner, in particular by at least partly fusing with one another, as a result of the expansion (and the softening or melting that takes place in the process). The expanded foam particles then (possibly after they have cooled down) form a continuous mold body of solid foam that has the shape of the defined space within which the foam particles were caused to expand.

The helmet body comprises at least one such solid foam. The helmet body may generally also comprise a plurality of solid foams that are spatially delineated from one another, possibly manufactured separately from one another. In this respect, it may be provided that all of these foams are formed from expanded foam particles of the same material or that one or more of these foams are formed from expanded foam particles of a different material than one or more other(s) of these foams.

It is not exclusively meant that the solid foam is formed from expanded foam particles. Rather, the solid foam may consist of more than just expanded foam particles. For example, particles such as flakes or fibers (cf. below) may be embedded in the solid foam.

According to the invention, it is provided that the helmet body further comprises particles of the second material that have an adhesive connection with at least some of the expanded foam particles of the first material.

“Particle” is in this respect to be understood as a collective term for parts or particles. The particles may in particular be granules, beads, foam particles, fibers, flakes, molded parts, textile parts or the like. In this respect, the particles are preferably small compared to the helmet body as a whole. In particular, it may be provided that the particles each have a volume that corresponds to at most one tenth, preferably at most one twentieth, in particular at most one fiftieth, of the volume of the entire helmet body. However, the particles may also be much smaller. In this respect, the particles may be joined with one another, also in a materially bonded manner, so that they may indeed together form a larger structure. However, the particles are preferably still structurally distinguishable from one another even when they have joined together to form such a larger structure, as is typically the case, for example, with the interjoined foam particles of a solid foam formed from them.

The adhesive connection between the particles of the second material and the foam particles of the first material is preferably a permanent connection. In this respect, the adhesive connection may in particular be permanent in that it cannot be released without damaging the helmet body.

Furthermore, the adhesive connection between the particles of the second material and the expanded foam particles of the first material is in particular a direct connection without an additional adhesive agent, such as glue or the like. Rather, the adhesion preferably results from the fact that the respective particles of the second material and the respective foam particles of the first material interact directly with one another in direct contact with one another. The particles of the second material may in particular adhere areally to the respective foam particles of the first material.

The particles of the second material are preferably joined in a materially bonded manner with at least some of the expanded foam particles of the first material. This material bonding may in particular result from an expansion of the foam particles of the first material in direct contact with the particles of the second material. The foam particles of the first material adjoining particles of the second material may in this respect fuse or stick together with the respective particle of the second material during the expansion, possibly as a result of a supply of heat.

In this regard, it is preferred if the foam particles of the first material and the particles of the second material are molded together to form the helmet body. This may in particular take place according to the technique mentioned in which the foam particles of the first material are caused to expand within a mold, in particular by supplying heat, and thus ultimately form a molded part of solid foam corresponding to the mold. Typically, the heat is in this respect supplied in the form of water vapor. To enable a joint molding of the foam particles of the first material and the particles of the second material for different materials, it is, however, preferred that the heat is supplied in the form of infrared radiation. For example, in this respect and in the method described below, the solid foam may be produced according to one of the ways described in WO 2017/109079 A1.

A method of manufacturing the helmet may comprise: that foam particles of a first material are filled into a common mold; that particles of a second material different from the first material are filled into the common mold; that the foam particles of the first material and the particles of the second material are molded together in the common mold (casting mold) to form a helmet body of the helmet, wherein this molding comprises that the foam particles of the first material are caused to expand so that the foam particles are joined with one another to form a solid foam which the helmet body comprises; and that at least some of the particles of the second material enter into an adhesive connection, in particular are joined in a materially bonded manner, with at least some of the expanded foam particles of the first material.

The method is in this respect not limited to a specific order in which the foam particles of the first material and the particles of the second material are filled into the common mold. They may generally also be filled at the same time or at least overlapping in time. The fact that the foam particles of the first material and the particles of the second material are molded together, in particular means that they are molded together to form the helmet body of the helmet (or at least a part thereof), and comprises at least the two method steps mentioned. In this regard, the joint molding may also be called co-molding and may in particular be performed at least substantially according to the aforementioned technique for forming a molded part from a solid foam.

In this respect, at least the foam particles of the first material are caused to expand, whereby they are joined with one another to form said solid foam, whereby it is not excluded that the solid foam contains further components, namely in particular the particles of the second material that may be embedded in the solid foam. In this respect, the foam particles of the first material may in particular adhere firmly to one another or fuse together. In particular, they are joined with one another in a materially bonded manner in this respect.

The particles of the second material may generally also be formed as foam particles and may likewise be caused to expand during said joint molding. In this case, not only are the foam particles of the first material joined with one another to form a solid foam, which the helmet body comprises, but the foam particles of the second material are also joined with one another to form a further solid foam which the helmet body comprises. The solid foam formed from the foam particles of the first material and the further solid foam formed from the foam particles of the second material may in this respect directly adjoin one another along one or more boundary surfaces and/or may overlap in an at least partly mixed manner within one or more boundary regions. Along a respective boundary surface or within a respective boundary region, the adhesive connection which the particles of the second material enter into with the expanded foam particles of the first material may then generally correspond to that type of connection which the foam particles of the first material enter into with one another and which the foam particles of the second material enter into with one another.

However, it may also be the case that the particles of the second material are not likewise formed as foam particles and cannot necessarily be expanded either. In this case, the expansion of the foam particles of the first material in the common mold together with the particles of the second material advantageously leads in any case to at least some of the particles of the second material entering into said adhesive connection with at least some of the expanded foam particles of the first material. This adhesive, in particular materially bonded, connection may result, for example, from the fact that expanded foam particles of the first material and particles of the second material at least partly fuse, for example due to the heat supplied. It may also be sufficient that only foam particles of the first material soften during the expansion and are urged towards particles of the second material, whereby they stick to the particles of the second material.

The invention also relates to a helmet that may be obtained by performing said method, wherein the method does not have to be limited to the aforementioned method steps, but may comprise further method steps for manufacturing the helmet, in particular further parts of the helmet. The design options of the helmet according to the invention that are described above and below also apply equally to the helmet that may be obtained by said method.

According to an advantageous embodiment, the first material is an expandable plastic. Any plastic from which expandable foam particles and, therefrom, molded parts may then be produced, may generally be considered in this respect. The expanded foam particles of the first material may in particular be expanded polystyrene (EPS), expanded polypropylene (EPP), expanded acrylonitrile butadiene styrene copolymer (EABS), expanded polycarbonate (EPC), expanded polyamide (EPA), expanded polybutylene terephthalate (EPBT), expanded polyethylene terephthalate (EPET), expanded modified polyphenylene ether (EmPPE), expanded thermoplastic polyurethane (ETPU), expanded polyoxymethylene (EPOM), expanded polymethyl methacrylate (EPMMA) and/or expanded polyether ketone (EPEK).

According to a further advantageous embodiment, said particles of the second material are foam particles (as already explained as a possibility with respect to the method), wherein the helmet body comprises a further solid foam of expanded foam particles of the second material.

The foam particles of the second material may at least substantially be formed in the same manner as the foam particles of the first material, i.e. they may at least substantially differ from the foam particles of the first material only by the respective material. In particular, corresponding to the foam particles of the first material, the foam particles of the second material may, as a result of an expansion, adhere to one another, be adhesively bonded to one another or, in particular if heat has been supplied to them for the expansion, be at least partly fused together. The foam particles of the second material are preferably joined with one another in a materially bonded manner. The foam particles of the second material may at least substantially have a spherical shape, in particular formed as foam beads or beads, and may, for example, have a maximum diameter in the order of millimeters (in particular in the range from 0.5 to 15 mm). As with the solid foam formed from the foam particles of the first material, the further solid foam formed from the foam particles of the second material is preferably a hard foam.

The further solid foam formed from foam particles of the second material does not necessarily have to comprise only the foam particles of the second material, but may also comprise further components, but preferably no foam particles of the first material (possibly except in said boundary regions). In this regard, the solid foam formed from the foam particles of the first material (which could also be called the first solid foam) and the further solid foam formed from the foam particles of the second material (which could also be called the second solid foam) are indeed joined with one another and are preferably also produced together, but are spatially delineated from one another (possibly except in said boundary regions).

This embodiment makes it possible that the helmet body of the helmet may be formed from solid foam throughout, but may in this respect have regions comprising solid foam of foam particles of the first material and other regions comprising solid foam of foam particles of the second material so that different regions of the helmet body may have different properties, for example shock absorption properties optimized for the respective region. Advantageously, this helmet body may in this respect be manufacturable by jointly molding the solid foams from the different materials in a common mold. This may in particular be possible by filling different regions of the common mold with foam particles of different materials that are then caused to expand comparatively quickly by heating, in particular by means of infrared radiation, without leaving the respective region in so doing. In this way, the foam particles of the first material and the foam particles of the second material in the common mold advantageously do not necessarily need to be separated from one another by walls, slides or the like.

During the expansion, therefore, not only are the foam particles of the first material joined with one another and the foam particles of the second material joined with one another to form a solid foam that at least substantially completely fills the respective region, but the different solid foams formed from the different expanded foam particles are also joined with one another in an at least adhering manner, preferably in a materially bonded manner.

According to an advantageous embodiment, the helmet body comprises at least a first section that comprises the solid foam of expanded foam particles of the first material, but not the further solid foam of expanded foam particles of the second material, and at least a second section that is separate from the first section and that comprises the further solid foam of expanded foam particles of the second material, but not the solid foam of expanded foam particles of the first material. The first section and the second section of the helmet body may each correspond to one of the aforementioned regions. The dimensions of the first section and the second section preferably each significantly exceed the dimensions of a single foam particle of the first material or the second material. In particular, it may be provided that the first section and the second section each extend in at least one spatial direction over at least 1 cm, preferably at least 2 cm, in particular at least 3 cm.

According to an advantageous further development of this embodiment, the first section and the second section are delineated from one another by a boundary section within which the solid foam of expanded foam particles of the first material and the further solid foam of expanded foam particles of the second material have an adhesive connection. A plurality of such boundary sections may also be provided. This boundary section may in particular correspond to a boundary surface or a boundary region, such as they were described above.

The adhesive connection is preferably produced directly between one or more expanded foam particles of the first material and one or more expanded foam particles of the second material, in particular without adhesive, i.e. without an additional adhesive agent, such as a glue, being provided for this purpose, but advantageously as a direct result of the joint molding. The adhesive connection is preferably permanent so that it cannot be released without damaging the helmet body.

Furthermore, it is preferred that the solid foam of expanded foam particles of the first material and the further solid foam of expanded foam particles of the second material are joined with one another in a materially bonded manner within the boundary section. For this purpose, where one or more foam particles of the first material and one or more foam particles of the second material are in direct contact with one another, they may be at least partly fused together.

If the helmet body comprises a further solid foam of expanded foam particles of the second material, it is advantageous if the second material is an expandable plastic. As with the first material, any plastic from which expandable foam particles and, therefrom, molded parts may then be produced, may generally be considered in this respect. The expanded foam particles of the first material may in particular be expanded polystyrene (EPS), expanded polypropylene (EPP), expanded acrylonitrile butadiene styrene copolymer (EABS), expanded polycarbonate (EPC), expanded polyamide (EPA), expanded polybutylene terephthalate (EPBT), expanded polyethylene terephthalate (EPET), expanded modified polyphenylene ether (EMPPE), expanded thermoplastic polyurethane (ETPU), expanded polyoxymethylene (EPOM), expanded polymethyl methacrylate (EPMMA) and/or expanded polyether ketone (EPEK).

According to a further advantageous embodiment, the second material is a natural material. The second material is preferably a natural material that may be shaped in the aforementioned manner, in particular may be foamed, preferably expanded. In this respect, a cork material is in particular suitable here so that the particles of the second material may be a cork granulate, for example. Similarly to the foam particles of the first material, such a material may be molded together with the foam particles of the first material in a common mold (in particular may also expand in so doing) to form the helmet body. Preferably, the particles of the second material may in this respect enter into a directly adhering connection, in particular an adhesive-free adhering connection, with one another and with adjoining expanded foam particles of the first material.

However, the particles of the second material may also be larger structures, in particular already formed structures composed of the respective natural material. For example, they may be molded parts composed of a cork material. The solid foam formed from the foam particles of the first material may then extend at least partly around such a molded part, wherein the foam particles of the first material are joined with the molded part in a directly adhering manner, preferably even in a materially bonded manner.

It is furthermore conceivable that the particles of the second material are formed as flakes (flakes, tufts). These flakes may be small pieces of a material that may be a shredded shell material, for example. In this respect, polycarbonate (PC) and polyethylene terephthalate (PET) are in particular considered as the material. It is preferably a recycled material.

According to a further advantageous embodiment, said particles of the second material are fibers. In this respect, all types of synthetic or natural fibers may be considered for these fibers. The second material may in particular be a glass material or a carbon material. In this regard, said fibers may therefore be glass fibers or carbon fibers.

The particles of the second material may, for example, be configured as a textile. For example, it is conceivable that they are pieces of a textile fabric, such as a woven fabric, or a textile area-measured material, for instance a felt. Similarly to as described above for the molded parts composed of a natural material, the solid foam formed from the foam particles of the first material may then extend at least partly around a respective piece of fabric of this kind, a felt piece or another textile piece formed from the fibers, wherein the expanded foam particles of the first material are joined with the respective textile piece in a directly adhering manner, preferably even in a materially bonded manner.

However, the particles of the second material may also be present as individual flakes, fibers or fiber bundles. In this form, the particles of the second material may each be arranged individually between foam particles of the first material. In this regard, the particles of the second material are mixed in with the foam particles of the first material. Due to the adhesive connection with preferably in each case a plurality of expanded foam particles of the first material, the particles of the second material may in this respect even additionally support the connection of the expanded foam particles of the first material with one another, in particular by creating additional cross-connections between the foam particles. In this way, the solid foam of the expanded foam particles of the first material may be advantageously reinforced by adding the particles of the second material.

In particular in this context, but also in principle irrespective of whether the particles of the second material are flakes, fibers or other types of parts, it is further advantageous according to a further embodiment if the helmet body has at least one section in which the particles of the second material are at least partly embedded in the solid foam of expanded foam particles of the first material. In this respect, the particles of the second material may in particular be embedded in the solid foam in that the particles of the second material are enclosed individually or in groups—at least within a respective plane (two-dimensionally; for example in a ring shape), preferably completely in all spatial directions (three-dimensionally)—by the solid foam of expanded foam particles of the first material. In this way, the particles of the second material and the expanded foam particles of the first material are in contact with one another in each case within a particularly large boundary surface or a particularly large boundary region and may therefore have a particularly comprehensive adhesive connection with one another.

### DRAWINGS

The invention will be explained further in the following only by way of example with reference to the Figures.

FIG. 1 shows an embodiment of a helmet according to the invention;

FIG. 2 shows some foam particles of a first material and some particles of a second material that are formed as foam particles and that adjoin one another along a boundary surface;

FIG. 3 shows foam particles of a first material and particles of a second material that are formed as foam particles, that are filled into a common mold to form a helmet body and that adjoin one another along a boundary region; and

FIG. 4 shows some foam particles of a first material together with some particles of a second material formed as fibers.

### DESCRIPTION OF THE INVENTION

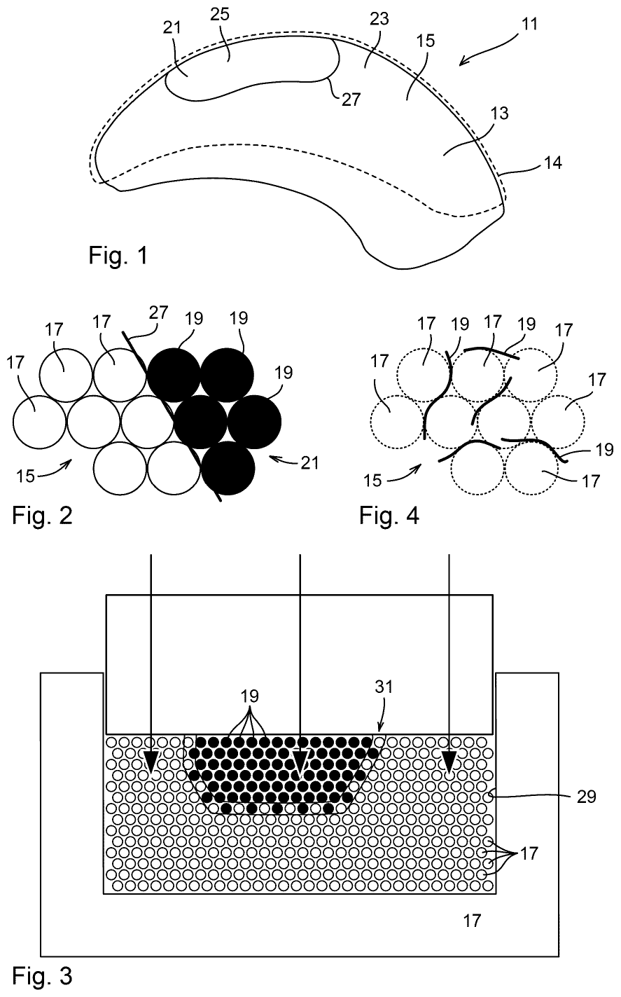

The Figures each show highly simplified schematic representations for illustrating the invention. In this respect, FIG. 1 shows an embodiment of a helmet 11 according to the invention comprising a helmet body 13 that comprises a solid foam 15 of expanded foam particles 17 of a first material and further comprises particles 19 of a second material. The foam particles 17 of the first material and the particles 19 of the second material are in this respect not visible in FIG. 1 due to their small size. The helmet body 13 has an at least substantially concavely shaped inner side (facing downwardly in FIG. 1) that faces the head of the wearer of the helmet 11 when the helmet 11 is put on. Furthermore, the helmet body 13 has an at least substantially convexly shaped outer side (upwardly facing in FIG. 1) opposite said inner side.

The helmet 11 furthermore comprises an outer helmet shell 14 that is arranged at the outer side of the helmet body 13 and covers it at least substantially completely. The helmet shell 14 is shown by an interrupted line in FIG. 1. It may be in particular be configured an injection-molded part composed of an injectable plastic, for example an acrylonitrile butadiene styrene copolymer (ABS). Furthermore, the helmet 11 may have further elements, such as straps for its fastening, padding for a comfortable fit on the head of the respective wearer, etc., that are not shown.

In the embodiment shown, the helmet body 13 comprises not only the solid foam 15 of expanded foam particles 17 of the first material, but also a further solid foam 21 of the particles 19 of the second material that are likewise formed as expanded foam particles in this embodiment. The solid foam 15 of expanded foam particles 17 of the first material may, for example, at least substantially consist of expanded polystyrene (EPS), while the further solid foam of the particles 19 of the second material formed as expanded foam particles may, for example, at least substantially consist of expanded polypropylene (PPP).

In this respect, the solid foam 15 and the further solid foam 21 are at least largely formed spatially separately from one another. The helmet body 13 thereby comprises a first section 23, which has the solid foam 15 of expanded foam particles 17 of the first material, but not the further solid foam 21 of the particles 19 of the second material formed as expanded foam particles, and a second section 25 that is separate from the first section 23 and that has the further solid foam 21 of the particles 19 of the second material formed as expanded foam particles, but not the solid foam 15 of expanded foam particles 17 of the first material. The first section 23 and the second section 25 adjoin one another along a boundary surface 27.

FIG. 2 shows, by way of example, some few expanded foam particles 17 of the first material and some few particles 19 of the second material that are formed as expanded foam particles and that adjoin one another along the boundary surface 27. So that the representation is not confusing, not all the foam particles 17 of the first material and all the particles 19 of the second material are in this respect marked with a respective reference sign (just as in FIGS. 3 and 4). The boundary surface 27 is shown as a line that, however, is only intended to illustrate the course of the boundary surface 27, but has no physical equivalent in reality.

In the Figures, the expanded foam particles 17 of the first material and the particles 19 of the second material, insofar as they are formed as foam particles, are each shown in simplified form as circles between which there are also intermediate spaces. This representation serves to show the individual expanded foam particles distinguishable from one another. In reality, the foam particles 17 of the first material shown in FIG. 2 and particles 19 of the second material formed as foam particles are expanded during the formation of the solid foam 15 or the further solid foam 21 such that all the intermediate spaces between them are largely filled. The same applies to the foam particles 17 of the first material shown in FIG. 4.

Due to the expansion, in particular due to the heat supplied in the process, the foam particles, which have at least temporarily softened, have come into close contact with their respective neighbors and have entered into an adhesive connection, which is preferably a materially bonded connection, with them. As a result, not only do the expanded foam particles 17 of the first material and the particles 19 of the second material formed as expanded foam particles enter into an adhesive connection with one another in each case, but along the boundary surface 27 at least some of the expanded foam particles 17 of the first material are joined in a directly adhering manner, preferably in a materially bonded manner, with at least some of the particles 19 of the second material formed as expanded foam particles.

In FIG. 3, the manufacture of the helmet body 13 of a helmet 11 according to the invention is shown in a highly simplified manner. In this respect, foam particles 17 of the first material and particles 19 of the second material formed as foam particles are filled into a common mold 29 in which they may be molded together to form the helmet body 13. The common mold 29 is in this respect shown in simplified form with a rectangular cross-section. In reality, however, the shape of the inner space of the common mold 29 at least substantially corresponds to the shape of the helmet body 13. Furthermore, both the foam particles 17 of the first material and the particles 19 of the second material formed as foam particles are shown much too large (and thus too few in number) in relation to the common mold 29 for them to be clearly recognizable.

The foam particles 17 of the first material and the particles 19 of the second material formed as foam particles are arranged within the common mold 29 in different regions that may in particular correspond to said first section 23 or said second section 25. In this respect, the foam particles may overlap in an at least partly mixed manner within a boundary region 31 (indicated by two lines in FIG. 3). However, the regions filled with different foam particles are substantially spatially delineated from one another.

After the filling into the common mold 29 and the closing of the common mold 29, the foam particles are caused to expand, in particular by exposure to infrared radiation (cf. arrows). As a result of the expansion (possibly after the contents of the common mold 29 have been cooled), the expanded foam particles 17 of the first material form the solid foam 15 and the particles 19 of the second material formed as expanded foam particles form the further solid foam 21. In this respect, the solid foam 15 and the further solid foam 21 are firmly joined with one another in the boundary region 31—due to the directly adhering connection, in particular a form-fitting connection, between at least some of the expanded foam particles 17 of the first material and at least some of the particles 19 of the second material formed as expanded foam particles.

Unlike in FIGS. 2 and 3, the particles 19 of the second material shown in FIG. 4 are not formed as foam particles, but as flakes, fibers or fiber bundles. They may in particular be raw materials such as glass fibers or carbon fibers or glass fiber bundles or carbon fiber bundles, but also plastic particles, in particular recycled materials such as shredded shell material composed of polycarbonate (PC) or polyethylene terephthalate (PET). In this respect, the flakes, fibers or fiber bundles are not spatially delineated from the expanded foam particles 17 of the first material, but are arranged at least substantially uniformly distributed between the expanded foam particles 17 of the first material (shown by dashed lines in FIG. 4). In this respect, they not interfere with the formation of the solid foam 15 from the expanded foam particles 17 of the first material in this respect, but are embedded in the solid foam 15 as an integral component thereof.

In this respect, the particles 19 of the second material formed as flakes, fibers or fiber bundles have an adhesive connection, in particular a materially bonded connection, with at least some of the expanded foam particles 17 of the first material. In particular, at least some, preferably the majority, of the particles 19 of the second material may be joined in an adhering manner with more than one expanded foam particle 17 of the first material in each case so that the foam particles 17 of the first material are not only joined with one another in a directly adhering manner, but are also at least partly joined with one another via the particles 19 of the second material. In this way, the solid foam 15 of the expanded foam particles 17 of the first material is advantageously reinforced by the particles 19 of the second material embedded therein.

What is claimed is:

1. A helmet, comprising a helmet body composed of at least a first material and a second material different from the first material,
wherein the helmet body comprises a solid foam of expanded foam particles of the first material, and
wherein the helmet body further comprises particles of the second material that have an adhesive connection with at least some of the expanded foam particles of the first material.

2. The helmet according to claim 1, wherein the particles of the second material are joined in a materially bonded manner with at least some of the expanded foam particles of the first material.

3. The helmet according to claim 1, wherein the first material is an expandable plastic, wherein the expanded foam particles of the first material comprise at least one of expanded polystyrene (EPS), expanded polypropylene (EPP), expanded acrylonitrile butadiene styrene copolymer (EABS), expanded polycarbonate (EPC), expanded polyamide (EPA), expanded polybutylene terephthalate (EPBT), expanded polyethylene terephthalate (EPET), expanded modified polyphenylene ether (EmPPE), expanded thermoplastic polyurethane (ETPU), expanded polyoxymethylene (EPOM), expanded polymethyl methacrylate (EPMMA) or expanded polyether ketone (EPEK).

4. The helmet according to claim 1, wherein the particles of the second material are foam particles, and wherein the helmet body comprises a further solid foam of expanded foam particles of the second material.

5. The helmet according to claim 4, wherein the helmet body comprises at least a first section that comprises the solid foam of expanded foam particles of the first material, but not the further solid foam of expanded foam particles of the second material, and at least a second section that is separate from the first section and that comprises the further solid foam of expanded foam particles of the second material, but not the solid foam of expanded foam particles of the first material.

6. The helmet according to claim 5, wherein the first section and the second section are delineated from one another by a boundary section within which the solid foam of expanded foam particles of the first material and the further solid foam of expanded foam particles of the second material have an adhesive connection.

7. The helmet according to claim 6, wherein the solid foam of expanded foam particles of the first material and the further solid foam of expanded foam particles of the second material are joined with one another in a materially bonded manner within the boundary section.

8. The helmet according to claim 5, wherein the second material is an expandable plastic, wherein the expanded foam particles of the second material comprise at least one of expanded polystyrene (EPS), expanded polypropylene (EPP), expanded acrylonitrile butadiene styrene copolymer (EABS), expanded polycarbonate (EPC), expanded polyamide (EPA), expanded polybutylene terephthalate (EPBT), expanded polyethylene terephthalate (EPET), expanded modified polyphenylene ether (EMPPE), expanded thermoplastic polyurethane (ETPU), expanded polyoxymethylene (EPOM), expanded polymethyl methacrylate (EPMMA) or expanded polyether ketone (EPEK).

9. The helmet according to claim 1, wherein the second material is a natural material.

10. The helmet according to claim 9, wherein the second material is a cork material.

11. The helmet according to claim 1, wherein the particles of the second material are fibers.

12. The helmet according to claim 11, wherein the second material is a glass material or a carbon material.

13. The helmet according to claim 1, wherein the helmet body has at least one section in which the particles of the second material are at least partly embedded in the solid foam of expanded foam particles of the first material.

14. The helmet according to claim 1, wherein the helmet is configured as a sports helmet or a work safety helmet.

15. A helmet that is obtained by performing a method that comprises:
that foam particles of a first material are filled into a common mold;
that particles of a second material different from the first material are filled into the common mold;
that the foam particles of the first material and the particles of the second material are molded together in the common mold to form a helmet body of the helmet,
wherein the molding comprises:
that the foam particles of the first material are caused to expand so that the foam particles are joined with one another to form a solid foam of the helmet body; and
that at least some of the particles of the second material enter into an adhesive connection with at least some of the expanded foam particles of the first material.

16. The helmet according to claim 15, wherein said particles of the second material are foam particles, wherein the helmet body comprises a further solid foam of expanded foam particles of the second material, and wherein the helmet body comprises at least a first section that comprises the solid foam of expanded foam particles of the first material, but not the further solid foam of expanded foam particles of the second material, and at least a second section that is separate from the first section and that comprises the further solid foam of expanded foam particles of the second material, but not the solid foam of expanded foam particles of the first material.

17. The helmet according to claim 15, wherein the second material is a natural material.

18. The helmet according to claim 17, wherein the second material is a cork material.

19. The helmet according to claim 15, wherein the particles of the second material are fibers.

20. The helmet according to claim 19, wherein the second material is a glass material or a carbon material.
